(19) United States
(12) Patent Application Publication
(10) Pub. No.: US 2008/0036287 A1
(43) Pub. Date: Feb. 14, 2008

(54) Spoke And Nipple Assembly For A Spoked Wheel, And A Spoked Wheel Including A Plurality Of Said Assemblies

(76) Inventors: Fabio Alberio, Cinisello Bolsamo(MI) (IT); Guido Cappellotto, Arcore (MI) (IT)

Correspondence Address: RATNERPRESTIA, P O BOX 980, VALLEY FORGE, PA, 19482-0980, US

(21) Appl. No.: 11/664,208

(22) PCT Filed: Sep. 27, 2005
(86) PCT No.: PCT/IT05/00550

§ 371 Date: Mar. 29, 2007

(30) Foreign Application Priority Data
Oct. 4, 2004 (IT) PD2004000241

(51) Int. Cl. B60B 1/04; B60B 1/02

(52) U.S. Cl. 301/58; 301/104

(57) ABSTRACT

A spoke and nipple assembly for a spoked wheel is described, which assembly is arranged to connect a rim and a hub in order to constitute the spoked wheel, wherein the nipple includes a shank which extends from an abutment member arranged to hold the nipple in one of the rim and the hub as far as the vicinity of the other of the rim and the hub, in order to constitute a predominant portion of the spoke.

This application is a U.S. National Phase Application of PCT International Application PCT/IT2005/000550 which is incorporated by reference herein.

### TECHNICAL FIELD

The invention relates to a spoke and nipple assembly for a spoked wheel and to a spoked wheel produced by assembling a plurality of said assemblies.

### TECHNOLOGICAL BACKGROUND

The technical solution proposed by this invention is particularly suitable for the manufacture of spoked wheels having spokes of light alloy, the spread of which is enjoying increasing success also owing to the fact that they permit a substantial reduction of the rotating masses while maintaining the same degree of strength.

A principal problem in the manufacture of such wheels is that of manufacturing spokes that have a structure which is strong and reliable over time, and that are not subject to yielding and that are readily adjustable for a correct adjustment of the wheel.

### BRIEF DESCRIPTION OF THE INVENTION

Those problems are solved by a spoke and nipple assembly for a spoked wheel. The assembly is arranged to connect a rim and a hub in order to constitute the spoked wheel. The nipple comprises a shank which extends from an abutment member arranged to hold the nipple in one of the rim and the hub as far as the vicinity of the other of the rim and the hub in order to constitute a predominant portion of the spoke.

Another aspect of the invention is a spoked wheel comprising a rim and a hub which are interconnected by means of an assembly as described above.

### BRIEF DESCRIPTION OF THE DRAWINGS

The features and advantages of the invention will emerge more clearly from the detailed description of some of its embodiments which are illustrated by way of non-limiting example with reference to the appended drawings in which:

FIG. 1 is a diagrammatic sectioned view of a spoked wheel manufactured in accordance with a first embodiment of this invention;

FIGS. 2 and 3 are diagrammatic sectioned views of a second and third embodiment, respectively, of a spoked wheel according to the invention;

FIGS. 4 to 6 are analogous diagrammatic sectioned views of further embodiments of a spoked wheel according to the invention.

### PREFERRED EMBODIMENTS OF THE INVENTION

In the drawings, a spoked wheel manufactured in accordance with the invention is generally indicated 1. The wheel comprises a rim 2 and a hub 3 which are joined to each other by means of a plurality of spoke and nipple assemblies which are respectively indicated 10 in the first embodiment, 20 in the second embodiment, 30 in the third embodiment, 40 in the fourth embodiment, 50 in the fifth and 60 in the sixth.

Analogous or technically equivalent parts will be indicated by the same reference numerals in the six embodiments described here.

The particular feature of this invention is that the spoke is substantially integrated with the nipple with which it is constrained on the one or the other of the rim and the hub.

In all of the embodiments, the nipple comprises a head 11 on which is formed an operating key 12, for example a polygonal key or a hexagonal socket or a flat-cut or cross-shaped key; at the base of the head 11 is a flange 13 constituting an abutment member with which the nipple is held inside a groove 14 in the rim in abutment therewith. A cylindrical shank 15, which is preferably manufactured integrally with the nipple, extends from the flange 13.

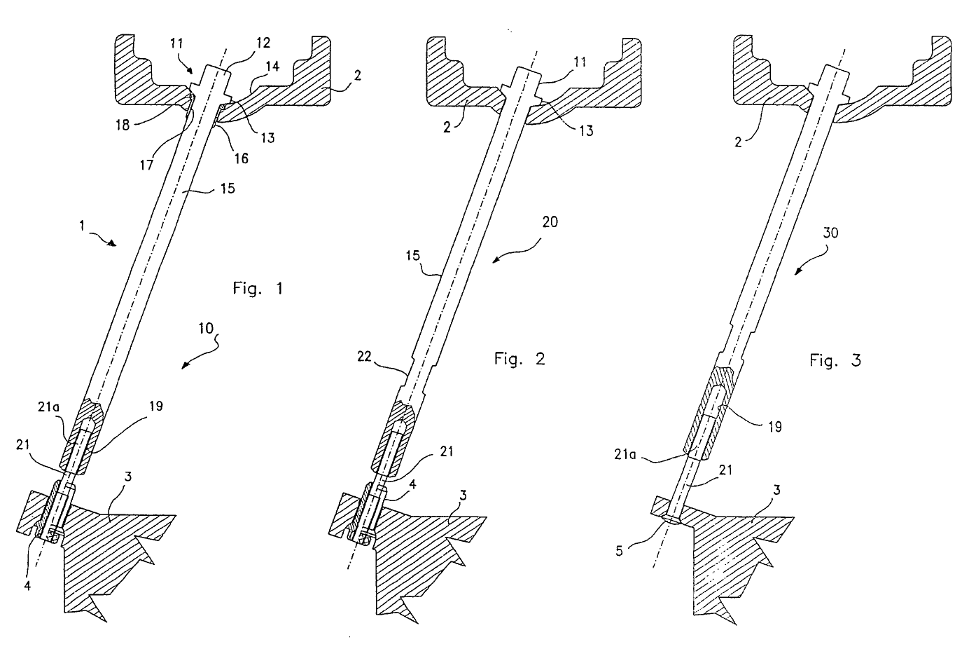

In the embodiment of FIG. 1, the end of the shank proximal to the flange 13 of the nipple has a thread 16 and is engaged in a hole 17 in the rim with the interposition of a seal 18.

This embodiment is suitable for the construction of wheels intended for the fitting of tires without an air chamber, so-called tubeless tires. However, this is not a preferred solution for this invention.

At the distal end of the shank relative to the flange 13 is a threaded axial hole 19 in which a threaded portion 21a of a tension rod 21 engages. In the embodiments of FIGS. 1 and 2, the tension rod 21 is connected in an adjustable manner to the hub 3 by means of an adjusting nipple 4 having a structure which is conventional per se.

The tension rod 21 and the shank 15 together constitute the stem of the spoke and are arranged one as the axial extension of the other.

In the embodiment of FIG. 2, the threaded coupling between the shank and the hole in the rim 2 provided in the previous embodiment has been eliminated. An auxiliary key 22 formed along the shank 15 and preferably in the vicinity of the distal end thereof relative to the flange 13 is also provided.

The embodiment of FIG. 3 differs from the previous embodiments owing to the fact that the threaded stem 21 has, at a free end thereof, a head 5, this term meaning any shaping suitable for locking the spoke axially. The adjustment of the wheel is obtained in this case by varying the screwing condition of the tension rod 21 in the hole 19.

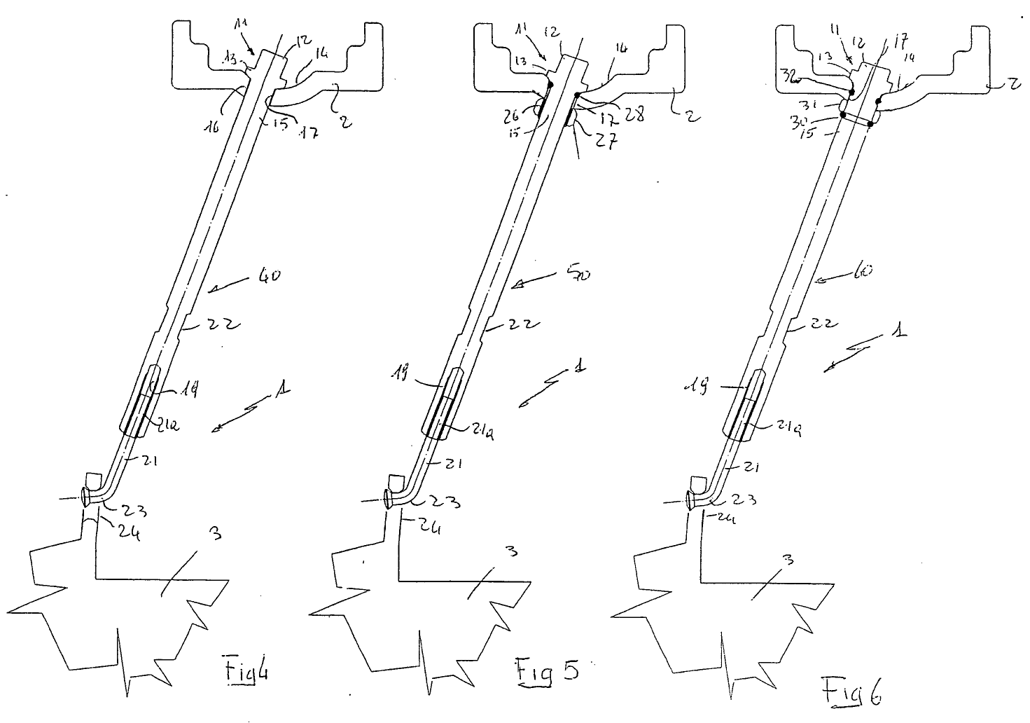

In the embodiment of FIGS. 4 to 6, the tension rod 21 has a head 23 which is of the elbow type, and which slides to a limited extent in a slotted seat 24 formed in the corresponding fringe of the hub 3.

In FIG. 5, the hole 17 in the rim is free from threading, while the corresponding portion 26 of the nipple is threaded and is in turn locked axially relative to the rim by means of a nut 27. The sealing between the rim and the nipple is provided by a seal 28 which is compressed between the groove 14 in the rim and the flange 13.

In the embodiment of FIG. 6, the stem 15 of the nipple and the associated hole 17 in the rim are free from threading, and locking is obtained by means of a resilient ring 30 with an interposed spacer 31, while sealing is provided by a seal 32 placed preferably along the axial length of the hole 17.

Preferably, the nipple with the associated shank of the embodiments described above is produced from aluminium alloy or another light alloy or else from composite materials based on carbon fibre or having an organic or metal matrix, while the tension rod 21 is produced from steel.

The invention thus solves the problem set, achieving numerous advantages over conventional spoke and nipple assemblies.

These include the substantial lightness, the ease of adjustment, and also the fact of providing a second, auxiliary, key which enables torsion in the shank of the nipple to be prevented during the mounting and adjustment of the wheel.

1. A spoke and nipple assembly for a spoked wheel, the assembly being arranged to connect a rim and a hub in order to constitute the spoked wheel, the nipple comprises a shank which extends from an abutment member arranged to hold the nipple in one of the rim and the hub as far as the vicinity of the other of the rim and the hub in order to constitute a predominant portion of the spoke.

2. The assembly according to claim 1, wherein the shank is integral with the nipple.

3. The assembly according to claim 1, wherein at least one key is provided on the nipple.

4. The assembly according to claim 1, wherein at least one key is provided on the shank.

5. The assembly according to claim 3, wherein one of the keys is formed on a head of the nipple.

6. The assembly according to claim 1, wherein the shank has, at a distal end remote from the abutment member, a coupling member of adjustable length with which the shank can be adjustably constrained on the other of the rim and the hub.

7. The assembly according to claim 6, wherein the coupling member comprises a tension rod as an extension of the shank.

8. The assembly according to claim 7, wherein the tension rod is provided for threaded coupling to an adjusting nipple.

9. The assembly according to claim 6, wherein the coupling member is a tension rod, and the tension rod is held in a hole in the distal end of the shank.

10. The assembly according to claim 9, wherein the tension rod is screwed into the hole.

11. The assembly according to claim 10, wherein the tension rod has, at a free end, a head.

12. The assembly according to claim 1, wherein the nipple, with the shank, is produced from light alloy.

13. A spoked wheel comprising a rim and a hub which are interconnected by means of an assembly of claim 1.

14. The assembly according to claim 2, wherein at least one key is provided on the nipple.

15. The assembly according to claim 2, wherein at least one key is provided on the shank.

16. The assembly according to claim 4, wherein one of the keys is formed on a head of the nipple.

17. The assembly according to claim 2, wherein the shank has, at a distal end remote from the abutment member, a coupling member of adjustable length with which the shank can be adjustably constrained on the other of the rim and the hub.

18. The assembly according to claim 7, wherein the tension rod is held in a hole in the distal end of the shank.

19. The assembly according to claim 8, wherein the tension rod is held in a hole in the distal end of the shank.

20. A spoked wheel comprising a rim and a hub which are interconnected by means of an assembly of claim 2.

21. A spoked wheel comprising a rim and a hub which are interconnected by means of an assembly of claim 6.
